(19) United States
(12) Patent Application Publication
(10) Pub. No.: US 2024/0357346 A1
(43) Pub. Date: Oct. 24, 2024

(54) Secure Unmanaged Network Switch and Related Methods

(71) Applicant: Zemfyre Inc., Thornhill (CA)

(72) Inventors: Yuri LUSKIND, Thornhill (CA); Alexandre GOURARI, Toronto (CA); Vassili NESTEROV, Richmond Hill (CA)

(21) Appl. No.: 18/682,884

(22) PCT Filed: Jan. 10, 2023
(86) PCT No.: PCT/CA2023/050022

§ 371 Date: Feb. 9, 2024

Related U.S. Application Data
(60) Provisional application No. 63/298,616, filed on Jan. 11, 2022.

(51) Int. Cl. H04W 12/0433; H04W 12/062

(52) U.S. Cl. CPC H04W 12/0433; H04W 12/062

(57) ABSTRACT

Unmanaged Ethernet switches are commonly used in the field for industrial communications and process automation but are at risk for security breaches. A secure unmanaged Ethernet switch (SUS) is herein provided for locking unused data ports and for locking media access control (MAC) addresses to specific data ports. A field technician uses a mobile device to communicate with the SUS over Near Field Communication (NFC) to establish a secure session between the SUS and the mobile device. During the secure session, the mobile device determines which data ports of the SUS are unlocked or are locked. During the secure session, the mobile device can provide permission to the SUS to receive firmware upgrades via a USB port or directly from the mobile device via NFC. Outside the secure session, a technician or adversary cannot lock or unlock data ports, nor upgrade the firmware of the SUS.

### CROSS-REFERENCE TO RELATED APPLICATION

This patent application claims priority to U.S. Patent Application No. 63/298,616 filed on Jan. 11, 2022, and titled “Secure Unmanaged Network Switch And Related Methods”, the entire contents of which are herein incorporated by reference.

### TECHNICAL FIELD

The following generally relates to a secure unmanaged network switch with integrated hardware and software security.

### DESCRIPTION OF THE RELATED ART

In Ethernet data networks, switches are used to connect devices together and transmit data between devices. A switch includes data ports and devices are connected to the switch via the data ports. The switch receives incoming data via a data port and outputs the incoming data to another data port based on a media access control (MAC) address, which identifies the destination device.

There are two main categories of switches: managed switches and unmanaged switches. Managed switches can be controlled remotely by a network administrator and include the highest level of management software and security software. Managed switches are used in large enterprise networks for large scale. Due to their complexity, managed switches are the most expensive category of switches. Smart switches and enterprise managed switches are other types of managed switches. For example, using a web or Internet interface, a network administrator can access a smart switch or another type of managed switch, or both. Many managed switches include a transmission control protocol or Internet protocol (TCP/IP) stack or architecture to control how data is communicated. They can be managed from other Ethernet network connected devices.

By contrast, unmanaged switches are plug-and-play and do not have configuration or interface options. Unmanaged switches cannot be controlled remotely by a network administrator or by another device on the Ethernet network. Unmanaged switches lack security features. Unmanaged switches do not have a processing unit and software running on the device. Accordingly, unmanaged switches do not have a TCP/IP stack. Due to their low cost, a large number of unmanaged switches are deployed in the industrial field to connect devices.

Turning to FIG. 1, in industries such as manufacturing, factory or building automation, power plant systems, heating-ventilation-and-air-conditioning (HVAC), process automation, mining operations, oil and gas drilling and processing, and farming operations, and, in broader terms industrial control systems, there are field level sensors, actuators, operator terminals, industrial equipment, and other devices that are connected to a network and form critical infrastructure for automation. These connected field level devices are defined in the Purdue model as devices level 0. These connected filed devices are part of the Industrial Internet of Things (IIOT), which are an important part of “Industry 4.0”. More generally, unmanaged switches are used across different industries.

In the field 101 (which may be a factory, a manufacturing plant, a robotic device in the field, a building, an industrial machine, a mine, a power plant, a farm, etc.), unmanaged switches 103a, 103b are commonly used to connect to connect to one or more of LAN/WAN devices, user/operator terminals, sensor devices, and Internet of Things (IoT) devices. Many unmanaged switches from different locations can be used in the field (e.g., different locations in a factory), and these unmanaged switches are connected to a Layer 2 or Layer 3 switch 102, which is a managed Ethernet switch. The switch 102 is data accessible via a data network 105 (such as the Internet or some other network) by a network administrator computer 106. The network administrator computer 106 can be a desktop computer, laptop, tablet, smartphone, or some other computing device that connects to the data network 105. In this way, the network administrator computer 106 remotely views and manages the switch 102, including the security of the switch 102.

In setup and management, a field technician 107 physically enters the field 101 to connect devices (e.g., user operator terminals, sensor devices, actuators, IoT devices, industrial equipment, etc.) to the unmanaged switches 103a, 103b, and to connect the unmanaged switches to the switch 102. This includes the field technician 107 manually plugging in connecting cables into the data ports of an unmanaged switch. By contrast to the managed switch, the unmanaged switches 103a, 103b are not remotely controllable or manageable by network administrator computer 106.

It is herein recognized that, due to the lack of security and the lack of diagnostics in unmanaged switches, a bad actor or adversary 108 can tamper with the field level devices and the network administrator would not have any knowledge of the tampering. For example, the adversary 108 can unplug a sensor device, which is currently plugged into a data port of an unmanaged switch, and plug into the same data port another sensor device in order to send false sensor data through the network. In another example, the adversary 108 can plug in a new device into a data port of the unmanaged switch to gain access to the network, either to send unwanted data or to obtain data. Unused data ports and data ports with existing plugged devices are both prone to security attacks. In other words, an adversary 108 can conduct man-in-the middle attacks, intercept an existing connection, and cause other security breaches at the level of the unmanaged switches. In another example, the adversary 108 can swap devices amongst data ports. These and other ways of tampering with the devices connected to the unmanaged switch can damage the security of the data network and compromise the security of the data itself.

Furthermore, it is herein recognized that many devices 104 are locally isolated and cannot easily connect to the Ethernet network 104. Examples of these devices include actuator devices, manufacturing devices, industrial devices, and IIOT devices. For example, unmanaged switches using typical Ethernet protocols have a limited distance range. A typical range limit for Ethernet cables is 100 meters. The limited distance can be too short for field devices and, therefore, cannot physically reach an unmanaged switch (or an unmanaged switch that is connected to the switch 102 cannot reach a locally isolated device 104). In another example, the locally isolated device is not Ethernet friendly compatible.

These locally isolated devices 104 are also prone to tampering by the adversary 108. A remotely located network administrator using their computer 106 cannot detect or stop the tampering done in the field 101.

It is herein desirable to address one or more of these technical security problems of the switches.

### BRIEF DESCRIPTION OF THE DRAWINGS

Embodiments will now be described by way of example only with reference to the appended drawings wherein:

FIG. 1 is a schematic diagram of a data network that includes field level devices connected to unmanaged switches, which are in turn connected to a managed switch, according to an example in the prior art.

FIG. 2 is a schematic diagram of a data network that includes a secure unmanaged switch connected to one or more devices, and field technician's mobile device in physically close communication with the secure unmanaged switch, according to an example embodiment.

FIG. 3 is a schematic diagram of a data network that includes a secure unmanaged switch connected to one or more devices, and the one or more devices include a gateway and a media converter, according to an example embodiment.

FIG. 4 is a schematic diagram showing the components of a secure unmanaged switch according to an example embodiment.

FIG. 5A is a schematic diagram showing the components of a secure unmanaged switch that includes Single Pair Ethernet (SPE) data ports and RJ-45 data ports, according to an example embodiment.

FIG. 5B is a schematic diagram showing the components of a secure unmanaged switch that includes power over data lines, according to an example embodiment.

FIG. 6 is a schematic diagram showing the components of a user device (e.g., that belongs to a field technician) in close data communication with the secure unmanaged switch, according to an example embodiment.

FIG. 7A is a flow diagram of processor implemented instructions and switch-executable functionality for locking or unlocking data ports (or both) in a secure unmanaged switch and interaction with a mobile device, according to an example embodiment.

FIG. 7B is a flow diagram of processor implemented instructions and switch-executable functionality for locking data ports in a secure unmanaged switch based on an automatic timer, according to an example embodiment.

FIG. 7C is a flow diagram of processor implemented instructions and switch-executable functionality for locking data ports in a secure unmanaged switch based on pre-stored lock configuration data, according to an example embodiment.

FIG. 8A is a flow diagram of processor implemented instructions, switch-executable functionality, and data tables in the secure unmanaged switch for processing an incoming Ethernet frame in a locked mode as well as in an unlocked mode, according to an example embodiment.

FIG. 8B is a flow diagram of processor implemented instructions, switch-executable functionality in the secure unmanaged switch for processing an incoming Ethernet frame in a locked mode as well as in an unlocked mode using an Access Control List and Dynamic MAC Address Table, according to another example embodiment.

FIG. 8C is a flow diagram of processor implemented instructions, switch-executable functionality in the secure unmanaged switch for processing an incoming Ethernet frame in a locked mode as well as in an unlocked mode using a Static MAC Address Table, according to another example embodiment.

FIG. 9 is a flow diagram of processor implemented instructions for a secure unmanaged switch to transmit log information (e.g., alert or error messages, diagnostic data, etc.), according to an example embodiment.

FIG. 10 is a flow diagram of processor implemented instructions for a secure unmanaged switch and a user device to download data from an external memory device.

FIGS. 11A, 11B, 11C, 11D, 11E, and 11F are screenshots of example graphical user interfaces shown on a user device for interacting with a secure unmanaged switch that is in close proximity, including setting the lock settings of the secure unmanaged switch, according to an example embodiment.

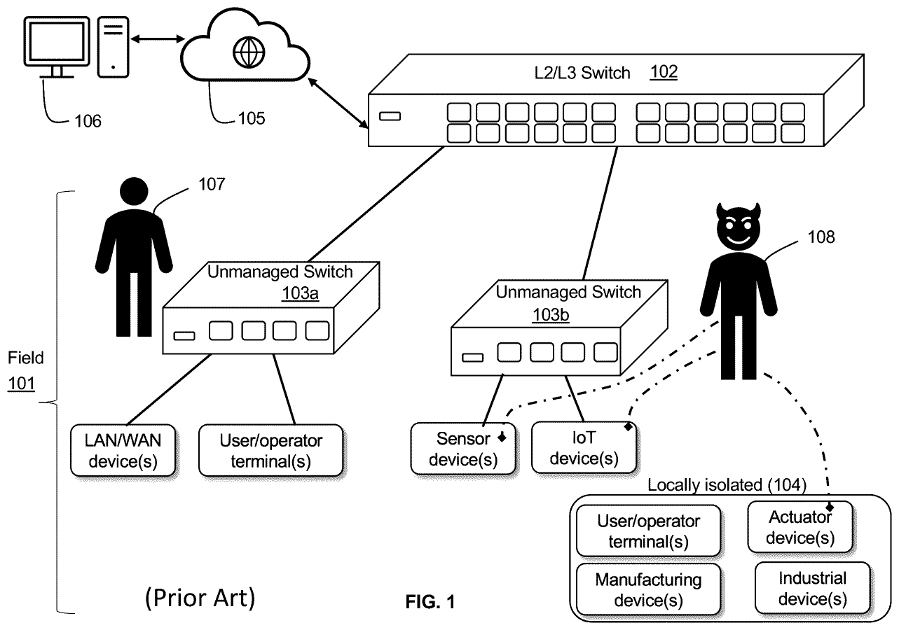

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

Within this specification, different structural entities (which may variously be referred to as “component”, “circuit”, “system”, “processor”, “module”, “interface”, “device”, other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform one or more tasks during operation. A structure can be said to be “configured to” perform some task even if the structure is not currently being operated. A “biosensor configured to collect biometric information” is intended to cover, for example, an integrated circuit that has circuitry that performs this function during operation, even if the integrated circuit in question is not currently being used (e.g., a power supply is not powering it). Thus, an entity described or recited “configured to” perform some task refers to something physical, such as a device, circuit, memory storing program instructions executable to implement the task, etc. This phrase is not used herein to refer to something intangible. Thus, the “configured to” construct is not used herein refer to a software entity, such as an application programming interface (API).

The term “configured to” is not intended to mean “configurable to.” An unprogrammed Field Programmable Gate Array (FPGA), for example, would not be considered to be “configured to” execute some specific operation, although it may be “configurable to” perform that specific operation and may be “configured to” execute that specific function after programming.

Reciting in the appended claims that a structure is “configured to” perform one or more tasks is intended not to be interpreted as having means-plus-function elements.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

In this specification, numerous specific details have been set forth. It is to be understood, however, that implementations of the disclosed technology may be practiced without these specific details. In other instances, well-known methods, structures, and techniques have not been shown in detail in order not to obscure an understanding of this description. References to “for example”, “some examples,” “other examples,” “one example,” “an example,” “various examples,” “one embodiment,” “an embodiment,” “some embodiments,” “example embodiment,” “an example aspect”, “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one embodiment,” or “in one implementation” does not necessarily refer to the same example, embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

It is herein recognized that networks that use unmanaged switches and managed switches (e.g., Layer 2 or Layer 3 managed switches) are prone to technical security problems at the field level (e.g., also called Level 0 in the Purdue model for industrial control systems) where the unmanaged switches are located. Therefore, a secure unmanaged Ethernet switch is herein provided, which includes a security framework, which can be used at the field level. In an example aspect, the secure unmanaged Ethernet switch is herein considered to be a new category of a network switch, different from a managed switch and different from an unmanaged switch.

In an example embodiment, a secure unmanaged Ethernet switch, also herein interchangeably called a “secure unmanaged switch” and a “SUS”, is a switch equipped with local security hardware and software controls. In an example aspect, the localized security hardware and software controls enable data ports to be locked or unlocked by a field technician in close physical proximity to the SUS. In another example aspect, the localized secured hardware and software enables data ports of the SUS to be automatically locked in a “plug and play” configuration. For example, client devices are plugged into the SUS and, automatically after a predetermined time, the data ports are locked. In another example, a pre-determined lock configuration profile is stored in non-volatile memory of the SUS during manufacturing or production, and the SUS automatically locks the data ports according to the configuration profile after being powered on or booted up. In another example aspect, the localized security hardware and software controls enable firmware to be updated by a field technician in close physical proximity to the SUS.

In an example embodiment, the SUS includes hardware and software that define security and control functions.

An example aspect of a security and control function is locking (or unlocking) an unused data port in the SUS. In a locked configuration of a specified unused port, even if a device is plugged in to the unused port (by an adversary or inadvertently by a field technician), the SUS prohibits data to be transmitted to or from (or both) the device. For example, this prevents an adversary from plugging in a device into the unused port to steal data or corrupt the data.

Another example aspect of a security and control function is locking (or unlocking) a used data port in the SUS to a specific device. In particular, in a locked configuration of a specified used port, the device that is plugged in the used port is locked, so that the MAC address of the device must be associated with the specified used port. No other MAC addresses can be used to send or receive data via the specified used port. For example, this prevents an adversary from intercepting data or switching devices in the port.

Another example aspect of a security and control function is to provide sticky MAC address and control, even after the SUS is rebooted (e.g., as part of power cycle). The previously stored locked and unlocked configurations for used data ports or unused data ports, or both, remains in place.

Another example aspect of a security and control function is a physical port to locally upload new software to upgrade the software of the SUS, or to locally upload predefined locking configurations, or to locally update security data (e.g., parameters, encryption keys, etc.), or to locally download log data, or a combination thereof. It will be appreciated that software includes firmware. In particular, a USB key or other local memory device is plugged into the physical port of the SUS to upload data. For example, this prevents a remotely located adversary from updating the firmware of the SUS as there is no option for a remotely located device on the Ethernet network to manage the SUS.

Another example aspect of a security and control function is a user device authentication process to execute locking and unlocking of ports, and to execute software upgrades. In particular, a user device of an authorized person (e.g., a field technician) and the SUS must be in close physical proximity to communicate with each other, such as over Near Field Communication (NFC) or another very localized communication medium, and to establish a secure communication session. In other words, NFC, or a similar close proximity communication module, ensures that the user device is very close in distance (e.g., within range of several centimeters) to the SUS, which increases security. The secure communication session is established Trust using currently known or future known trust verification protocols. In an example embodiment, the secure communication session is established by key exchange, and the encryption keys are stored on in a hardware security module (HSM) or similar in the SUS. In the secure session, data is encrypted and then transmitted between the user device and the SUS. For example, this prevents an adversary without an authorized user device to change the lock configuration of data ports. This also prevents an adversary without an authorized user device to upload or modify data of the SUS. The user device, for example, is a mobile device, such as a smart phone, tablet, or laptop.

Another example aspect of a security and control function is to limit any changes to the SUS to be performed through an authorized user device that is in close proximity to the SUS (e.g., via NFC or another close proximity communication medium). In particular, changes to switch configurations, encryption keys, authorized software updates, ID assignment, and unpowering the SUS, amongst other changes, are all performed through a secure channel between the authorized user device and the SUS.

It will also be appreciated the SUS is an alternative to the unmanaged switch, while providing security for field level Ethernet critical infrastructure. In another example aspect, a large number of SUS units can be deployed into the field at lower cost compared to managed switches, and at a cost comparable to unmanaged switches.

In another example aspect, the SUS does not have a TCP/IP stack or any other form of network management. In another example aspect, the SUS control and functionality is inaccessible by a remotely located network administrator. In other words, the SUS cannot be remotely managed. These are features similar to an unmanaged switch.

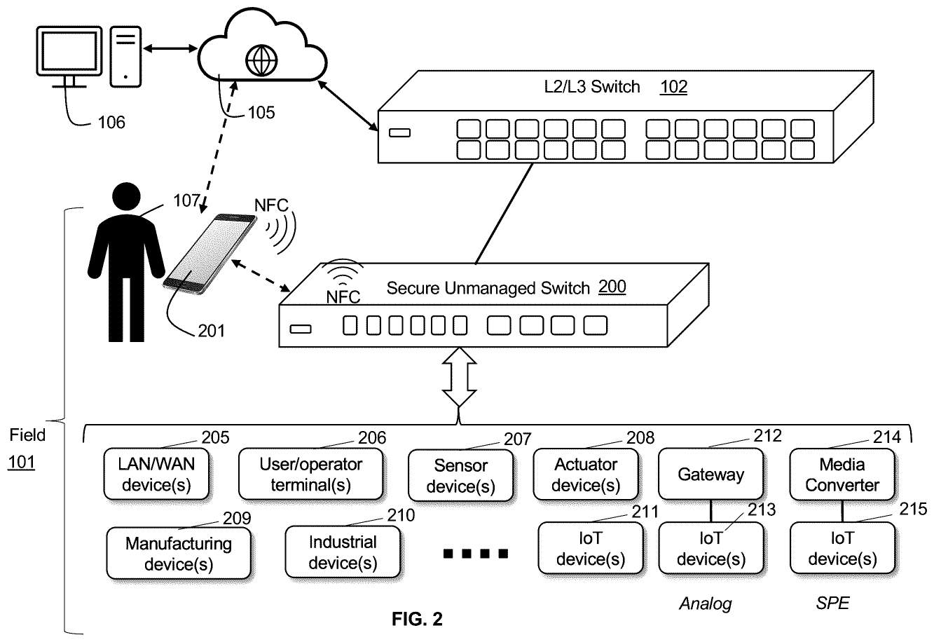

Turning to FIG. 2, a SUS 200 is positioned in the field 101. The SUS includes data ports that can connect to one or more devices via data cables. Examples of these one or more devices include a LAN/WAN device 205, a user or operator terminal 206, a sensor device 207, an actuator device 208, a manufacturing device 209, an industrial device 210, and an IoT device 211.

Some devices 213 are analog devices and cannot connect directly to the SUS 200, which operates on an Ethernet protocol. Therefore, one more of such devices 213 are plugged into a gateway 212, which processes the data from the devices 213, and the gateway 212 transmits the device data to the SUS 200.

Some devices 215 are also in a different physical layer and such a device 215 is connected to a media converter 214. The media converter interfaces with different physical layers, which is appropriate for the SUS configured for single pair Ethernet, or some other type of physical layer.

The SUS 200 wirelessly communicates with an authenticated user device 201 that is in close distance. The user device 201 is also herein called a mobile device. For example, the field technician 107 has user device 201 that communicates with the SUS 200 over NFC. While Near Field Communication is preferred, other types of currently known and future known close proximity communication can be used, including Bluetooth™ communication. Other types of close proximity communication include other types of radio frequency identification protocols.

In an example embodiment, the mobile device 201 also communicates with a network administrator computer 106 via the data network 105, such as through cellular connection or Wifi connection. For example, the mobile device 201 may be used to obtain security data from the network administrator computer 106, that in turn is used to authenticate the mobile device with the SUS 200. In another example, the mobile device 201 obtains software data from the network administrator computer, which is to be uploaded to the SUS 200. In another example, the mobile device 201 obtains status data and history logs from the SUS 200, and then the mobile device 201 transmits this data to the network administrator computer.

In an example embodiment, the SUS 200 is part of an Ethernet Gateway device. In other words, the function of the SUS 200 is combined with an Ethernet Gateway device.

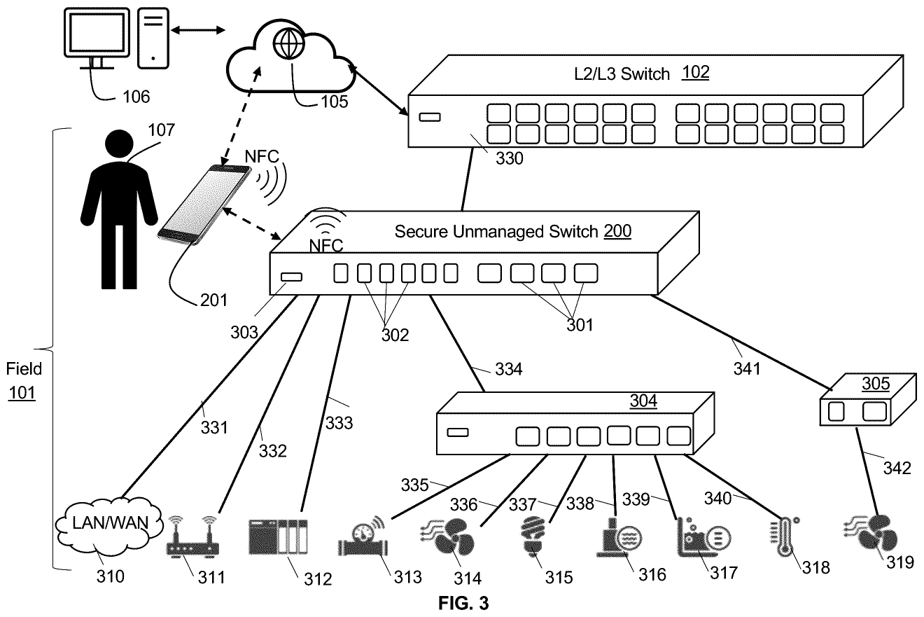

Turning to FIG. 3, another example embodiment is shown in which the SUS 200 includes RJ45 data ports 301 for accommodating more common Ethernet protocols (e.g., 10/100/1000BASE-T) and single pair Ethernet (SPE) data ports 302 for accommodating the Ethernet protocol 10BASE-T1L, 10BASE-T1S, or 100/100BASE-T1. Other protocols for SPE are applicable. In an example embodiment, SPE data port and cabling comply with the specifications in IEC 63171-1, part of the IEEE 802.3cg standard. Other specification of the IEEE 802.3cg standard as applicable to SPE may be applied to the SUS 200. Other specifications defining connectors and cabling for using SPE may be applied. Power port 303 is also shown for powering the SUS 200.

The Ethernet cable 330 between the managed switch 102 and the SUS 200 connects to the SUS 200 using a RJ45 data port 301.

The field devices connect to the SUS 200 using SPE data ports 302. The cabling for the SPE, also called single twisted pair, using the protocol 10BASE-T1L (or another protocol compatible with SPE) can support transmission of data of over 1 kilometer, even reaching a distance of 1.7 kilometers. This allows devices to be placed at considerable distance from the SUS 200, thereby extending the reach of the industrial data network.

For example, a local area network or wide area network hub 310 is connected with a cable 331 to the SUS 200 using a SPE data port. Similarly, wireless router 311 is connected by a cable 332 to the SUS using a SPE data port. Industrial machinery 312 is connected by a cable 333 to the SUS using a SPE data port.

A gauge 313 is connected via a cable 335 to a gateway device 304, and the cable supports the Modbus RTU, which is an open serial protocol. An air flow controller 314 and a light controller 315 are respectively connected via cables 336 and 337 to the gateway device, and these cables support RS485 serial protocols. Liquid sensor 316, chemical sensor 317 and temperature sensor 318 are respectively connected via cables 338, 339, and 340 to the gateway 304, and these cables support analog data. The gateway 304 processes the data from the devices 313, 314, 315, 316, 317, 318 into a format suitable for transmission over SPE. In particular, the gateway 304 includes a SPE data port, which is connected to a cable 334, and the cable 334 is connected to a SPE data port of the SUS.

A fan controller 319 is connected via a cable 342 to a media converter 305, and the cable 342 supports one or more of a 10/100/1000BASE-T protocol. The media converter includes both a RJ45 data port and a SPE data port; the RJ45 data port is connected to cable 342 and the SPE data port is connected to the cable 341. Through the cable 341, the media converter is connected to another SPE data port on the SUS 200. In an example aspect, the media converter converts the data from one or more of a 10/100/1000BASE-T protocol to a 10BASE-T1L protocol.

In an example aspect, a kit of parts is provided that includes one or more SUS devices and one or more media converters.

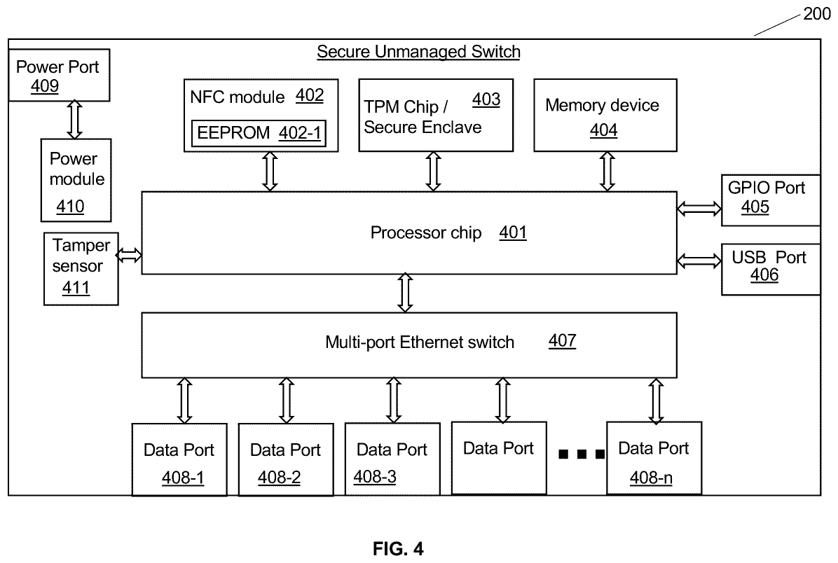

Turning to FIG. 4, example components within a body of a SUS 200 are shown. The components include a processor chip 401. An NFC module 402, a secure cryptography processor 403 that is also called a trusted platform module (TPM) chip, a memory device 404, a general purpose input output (GPIO) port 405, and a universal serial bus (USB) port 406 are some of the components in data communication with the processor chip 401. In an example aspect, the TPM chip 403 is also called a secure enclave or a hardware security module. In an example aspect, the NFC module 402, for example, includes an electrically erasable programmable memory (EEPROM) 402-1, or another type of memory. In an example aspect, the processor chip 401 is a microcontroller unit (MCU).

In an example embodiment, the EEPROM 402-1 of the NFC module 402 is populated with configuration data during the manufacturing or production process. The configuration data can be stored (also called “burned”) onto the EEPROM without powering the SUS 200, which makes this data storage process more efficient during manufacturing or production. In an example aspect, after powering on the SUS, the configuration data is automatically processed by the processor and may also be used to automatically affect the multi-port Ethernet switch 407.

For example, configuration data stored on the EEPROM 402-1 includes one or more of: the SUS device ID, SUS device name, designated location of the SUS device, other profile data, and other configuration data. In another example aspect, the configuration data stored on the EEPROM includes a locking configuration. The locking configuration, also herein called locking config or lock config, includes a predefined association of SUS data ports to MAC addresses or device names, or both. The locking configuration can also include a predefined one or more SUS data ports that are to remain unused. The locking configuration can also include a predefined one or more SUS data ports that are to remain unlocked. After the SUS is powered on, the processor chip 401 obtains the locking configuration from the EEPROM and sends the locking configuration to the multi-port Ethernet switch 407. In turn, the multi-port Ethernet switch 407 writes the locking configuration into its hardware.

While the configuration data is described above as being stored in the EEPROM of the NFC module 402, in other example embodiments the configuration data is stored on a non-volatile memory device on the SUS 200. In other words, the configuration data does not have to be stored on the EEPROM of the NFC module 402, but can be pre-loaded during manufacturing or production onto any non-volatile memory device on the SUS 200 that is in data communication with the processor chip 401.

A multi-port Ethernet switch 407 is within the SUS and is connected to the processor chip 401. The multi-port Ethernet switch 407 is connected to data ports 408-1, 408-2, 408-3, . . . , 408-n. In the example shown, the data ports can be of the same connector type. In another example, the data ports are of different types.

The SUS 200 also includes a tamper sensor 411, which is in data communication the processor chip 401. The tamper sensor is configured to detect if the casing or body of the SUS has been tampered. For example, the tamper sensor is a light sensor positioned within the SUS body. In a secure and nominal operation, the space within the body (or casing) of the SUS is dark. However, if the body (or casing) is opened so that the internal hardware components are accessible, then the light sensor will detect the presence or increased presence of light. In another example, the tamper sensor is a mechanical switch that detects if the body (or casing) is opened. Other types of tamper sensors can be used.

A power port 409 receives power, which is transmitted to a power module 410, and the power module distributes the power over a power bus to the components in the SUS.

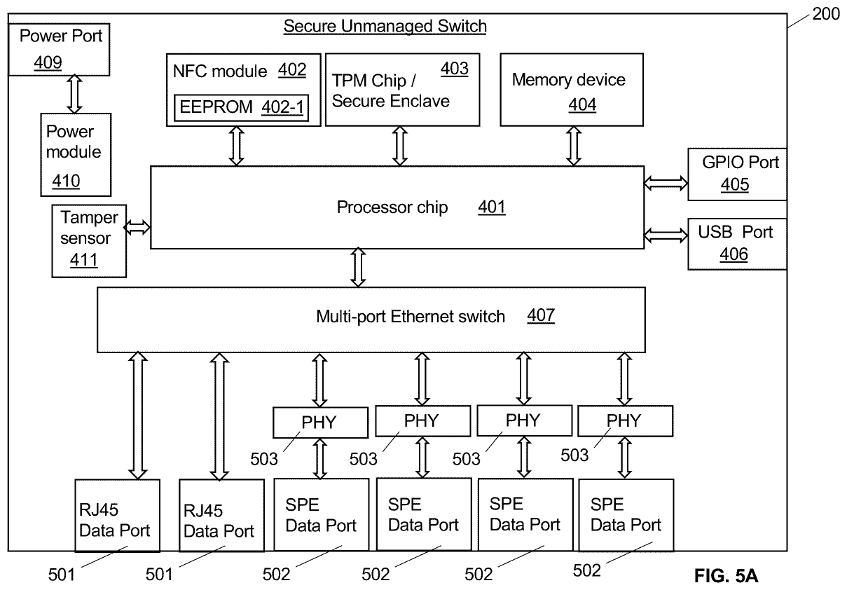

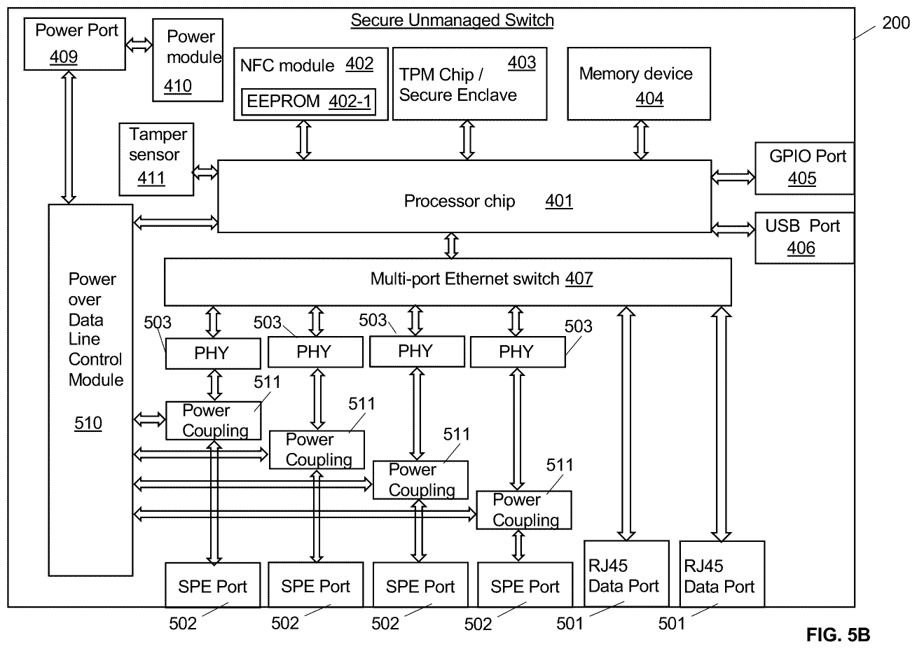

Turning to FIG. 5A, another example embodiment is shown that specifically accommodates SPE data ports 502 and RJ45 data ports 501. The RJ45 data ports connect directly to the multi-port Ethernet switch 407, which accommodates a 10/100/1000BASE-T protocol. Each of the SPE data ports connect to a PHY device 503, and each of the PHY devices connect to the multi-port Ethernet switch 407. In an example aspect, the PHY device, or also herein called PHY, is a 10BASE-T1L PHY device. An Ethernet PHY is a physical layer transceiver device for sending and receiving Ethernet frames based on the Open System Interconnection (OSI) network model. In an example aspect, the SUS 200 includes more SPE data ports 502 than RJ45 data ports. In an example embodiment, the SUS includes two RJ45 data ports and four or more SPE data ports. In another example embodiment, there are PHY devices supporting fiber optic Ethernet, four (4) pair Ethernet, and other types of Ethernet. It will be appreciated that different types of Ethernet can be used with the SUS, and the SUS can be configured to accommodate these different types of Ethernet.

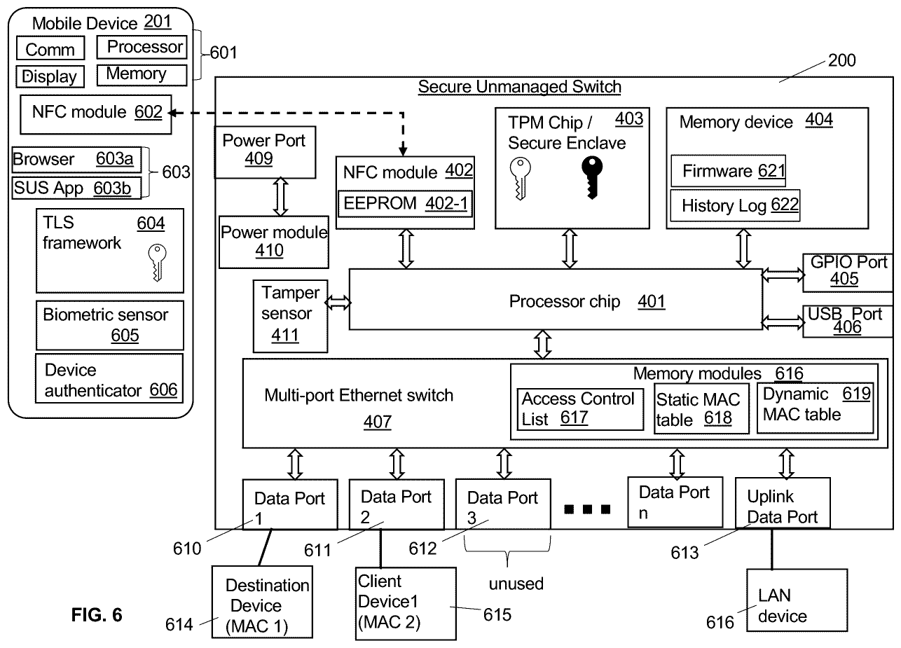

Turning to FIG. 6, example components of a mobile device 201 are shown. Examples of mobile devices include laptops, tablets, smart phones, smart watches, etc. Some examples of mobile devices include devices from Apple®, any other mobile device running Apple's iOS® operating system, any other mobile device running Google's Android® operating system, and any other mobile device running Microsoft's Windows® operating system. Other mobile devices that run other types of currently-known and future-known operating systems can also be used according the principles described herein.

A mobile device 201 includes hardware components 601, examples of which include a processor, memory, a communication module (e.g., for communicating via a cell network, WiFi, LAN, WAN, etc.), and a user interface (e.g., display screen, touch interface, keyboard, etc.). These hardware components 601 can vary in type, number and architecture as mobile devices continue to develop. The mobile device 201 also includes a NFC module 602, or another type of close proximity communication module, to communicate with the SUS 200. In an example aspect, the mobile device 201 includes a browser 603a, or a native application (also called a SUS app) 603b, or both. The browser 603a or the SUS app 603b, or both, are more generally herein referred to as the user agent 603. The user agent 603 displays a graphical user interface (GUI) on a display screen to guide the user through the authentication process and the related action (e.g., logging in, executing a command, a transaction, accessing data, etc.).

The mobile device establishes trust with the SUS. For example, the mobile device uses a transport layer security (TLS) framework module 604 to store and manage authentication data on the device in a secure manner. The TLS framework is used to establish a secure communication session with the secure unmanaged switch over NFC, or another close proximity wireless communication protocol. Another example of a close proximity wireless communication protocols includes Bluetooth™.

In an example embodiment, the mobile device 201 also includes a biometric sensor 605 and a device authenticator 606, which can be used to authenticate the user before using the user agent 603 to interact with the SUS 200. In another example aspect, the biometric sensor 605 and the device authenticator 606 are used to authenticate the user before executing certain functions (e.g., locking or unlocking data ports on the SUS, or both).

In an example aspect, the device authenticator 606 includes a secure execution and secure storage environment, which can be implemented using one or more of: a Trusted Execution Environment (TEE); a secure element, a firewall; a software layer; a secure enclave; a Hardware Secure Module (HSM); etc. It will be appreciated that a TEE is a computing chip that, for example, exists on a processor device. It will be appreciated that a HSM is a separated computing appliance. Authentication data about a user 107 can be stored in the device authenticator. The authentication data about the user, for example, includes a device authentication private key (also referred to as a DA private key) associated with the user 107 and the device authenticator 606 of the mobile device 201. The device authenticator 606, for example, interacts with the biometric scanner 605 to obtain identifying data about the user, and compares the scanned identifying data about the user with stored identifying data about the user. For example, the identifying data about the user is biometric authentication data, including and not limited to one or more of: fingerprint scan, eye scan, facial recognition, etc. The scanner 605 includes one or more sensors that can capture the biometric authentication data. While some embodiments use the biometric sensor to authenticate the user, in other embodiments, there is no biometric authentication and the user can access the user agent using alternative authentication or using no authentication.

The mobile device 201 and the SUS 200 use their NFC modules to establish trust. In an example aspect, a key exchange takes place to establish an encrypted session between the mobile device 201 and the SUS 200. The keys of the SUS are stored on the TPM chip 403.

In an example embodiment, a public key infrastructure (PKI) is used to establish the secure communication between the devices. In an example aspect, a PKI private key is securely stored on the TPM chip 403, and it is used to verify incoming data from a mobile device. In an example aspect, PKI key creation occurs during production of the SUS by the equipment supplier. Other currently known and future known encryption and authentication computations can be used to establish a secure communication session and to transmit encrypted data between the mobile device and the SUS.

In another example embodiment, there is no TPM chip 403 on the SUS 200. Instead, the keys that are used for a key exchange are stored on the processor chip 401 or are stored on another memory 404.

Turning to FIG. 5B, another example embodiment is shown of the SUS 200, which includes power over Ethernet. In particular, the SUS 200 further includes a power over data line control module 510. A power coupling 503 is electrically connected between each PHY device 503 and each SPE data port 502. There are several sets PHY device 503, power coupling 511, and SPE port 502. The power over data line control module 510 is connected to each power coupling 511.

The power over data line control module 510 obtains power from the power port 409, or, alternatively it can obtain power off another dedicated power port. The power over data line control module 510 converts incoming power into power suitable for delivery into SPE ports 502, now not just data ports but both data and power. The term “suitable power” used herein may mean one or more of: a specified voltage, a specified current limit and power allocation, galvanic isolation, inrush limitation, and noise filtering.

In addition to conversion functionality, the power over data line control module splits incoming power into individual channels each associated with a corresponding SPE port and each having individual associated voltage and current limit. These individual channels may carry power and low-speed communication used to establish power requirements according to an end device connected to SPE port. These individual channels may also transmit status data of the end devices (that are connected to the SUS 200) to the power over data line control module 510. Examples of the status data include: power fault, overheating, and sleep mode.

In order to isolate power with low-speed communication and high-speed data communication, the power coupling modules 511 are used. Each power coupling module comprises passive elements, such as inductors and capacitors.

As can be seen in FIG. 5B, the power over data line control module 510 is connected to the processor chip 401. The processor chip 410 transmits control commands to the power over data line control module 510. Examples of the control commands sent to the control module 510 includes: initiate power negotiation with an end device on a selected SPE port, enable or disable power on a selected SPE port, check status of an end device on a selected SPE port, and react to a fault or an alarm condition of an end device. Examples of fault or alarm conditions include: device disconnect, short circuit, overcurrent, and sleep mode.

A user device can wirelessly transmit commands to the processor chip 401, via the NFC module 402, to control the power over data line control module 510. For example, via NFC, the user device can trigger the processor chip 501 to transmit one or more control commands (as noted above) to the control module 510.

Also shown in FIG. 6 are memory modules 616 that are part of the multi-port Ethernet switch, which stores thereon an access control list (ACL) 617, a static MAC address table 618, and a dynamic MAC table 619. These are used to control the locking and unlocking of the data ports.

The memory device 404, which is accessible by the processor chip 401, stores the firmware 621 and a diagnostic and history log 622. The diagnostic and history log 622 includes, for example, anomalies, unauthorized MACs (e.g., that where blocked), time stamps and IDs of secure communication sessions with authenticated mobile devices, failed attempts to establish secure communication session with an authenticated device, locking actions associated with time stamps, unlocking actions associated with time stamps, firmware history log, tamper data from the tamper sensor 411, etc.

A destination device 614 having a first MAC address (MAC1) is connected to data port #1 610 of the SUS. A client device 615 having a second MAC address (MAC2) is connected to data port #2 611 of the SUS. The client device sends data to the destination device (and optionally vice versa) via the SUS 200. Data port #3 612 remain unused. An uplink data port 613 sends data to the rest of the IT/OT LAN through a device 616. An example of the device 616 is the L2/L3 managed switch 102.

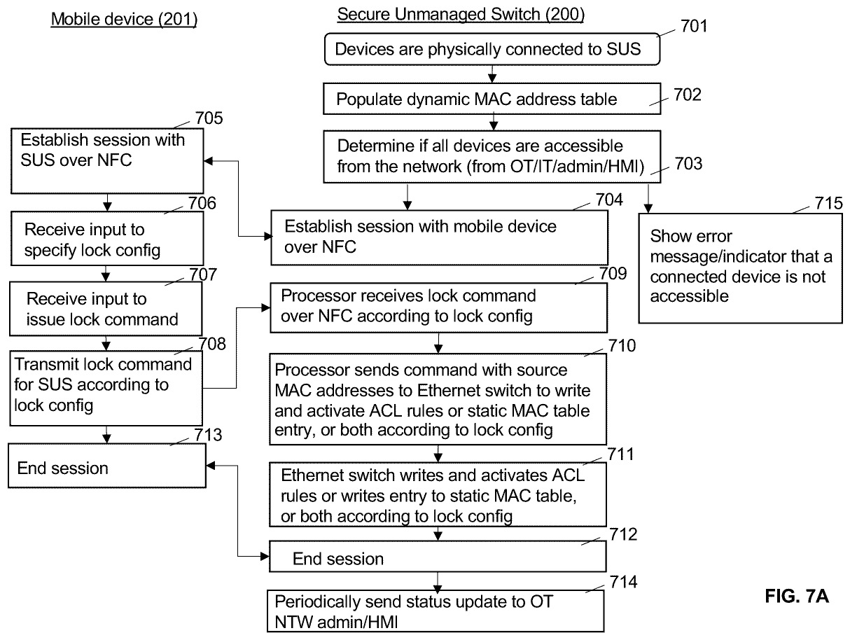

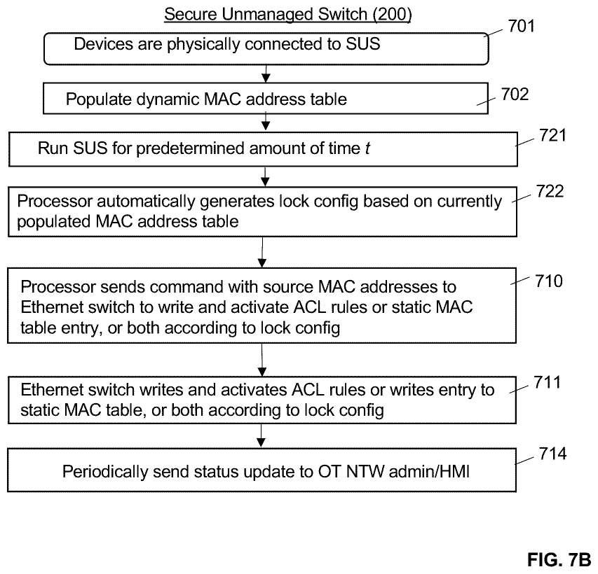

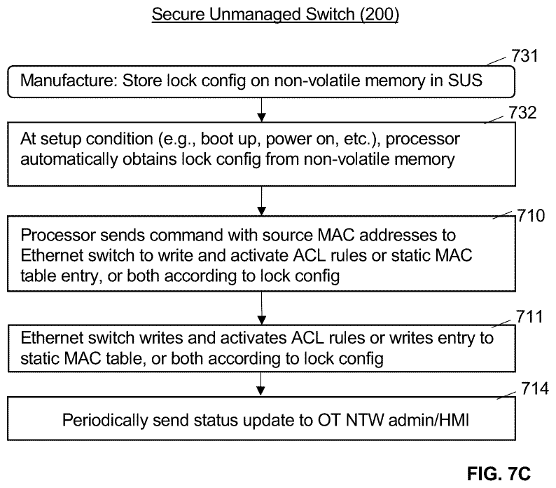

Turning to FIG. 7A, an example embodiment of executable instructions is provided for locking one or more data ports.

Block 701: One or more devices are connected to the SUS via its one or more data ports.

Block 702: The SUS (or more particularly the multi-port Ethernet switch 407) automatically populates the dynamic MAC address table 619. This is part of the learning process of the multi-port Ethernet switch 407.

Block 703: In an example embodiment, for further verification, the SUS determines if all devices are accessible from the network (for example, from an administrator interface. The interface can be for an operational technology (OT) or information technology (IT) administrator. For example, the SUS sends a listing of all connected devices to the network administrator computer 106, and the network administrator computer 106 sends a message to the field technician's mobile device 201 with the listing of all connected devices. If the listing of all connected devices matches the field technician's expectation of what he or she sees at the SUS, then the field technician has completed verification and can proceed with locking or unlocking ports. After verification is successful, then the process continues to block 704. Alternatively, after verification has filed, the process continues to block 715. It will be appreciated that this verification step is optional.

Block 704: The SUS establishes a session with a mobile device 201 over NFC using the NFC module 402.

Block 705: The mobile device establishes session with the SUS 300 over NFC using its own NFC module 602.

In an example embodiment, as part of the session, the SUS transmits to the mobile device one or more of the following context data: a name or ID of the SUS; a listing of all the data port IDs of the SUS; a listing of the source MAC address of the devices currently plugged in to the data ports where applicable; a listing of the device names or IDs currently plugged into the data ports where applicable; a listing of the locations of devices currently plugged into the data ports where applicable; and a listing of unused data ports, in which no device is plugged in. This context data is viewable in a GUI on the mobile device 201. The field technician can review this information when deciding which one or more data ports should be locked or unlocked. The data port ID is typically a number, but other types of IDs can be used to identify one data port from another.

When a given data port is locked, the MAC address of a given device currently plugged into the given data port is associated with the given data port as rule-based locked configuration in the SUS. In other words, after the given data port with the given device (which is identifiable by the MAC address) is locked, only the given device can send messages or receive messages (or both) via the given data port.

Block 706: The mobile device receives input to specify a lock configuration. For example, a user provides input via graphical user interface of the user agent 603 to specify which one or more data ports on the SUS are to be locked or unlocked. Alternatively, pre-set configurations are stored or accessible on the mobile device, and a pre-set configuration is selected by the user (or is automatically selected by the user agent 603) to lock or unlock the data ports (or both). An example of a pre-set lock configuration is to lock all data ports. Another example of a pre-set configuration is to lock a certain subset of the data ports.

Block 707: The mobile device receives input to issue a lock command, which is based on the specified lock configuration.

Block 708: The mobile device transmits the lock command to the SUS (over NFC or a similar close proximity communication technology) according to the specified lock configuration.

Block 709: The SUS processor chip 401 receives the lock command over NFC according to the lock configuration.

Block 710: The processor chip 401 sends a command to the multi-port Ethernet switch 407 to write and activate ACL rules in the ACL 617, or to write an entry in the static MAC address table 618, or both, according to the specified lock configuration.

Block 711: The multiport Ethernet switch 407 writes and activates the ACL rules or writes entry to static MAC address table, or both, according to the lock configuration.

For example, if a specified data port of the SUS is to be locked, then an ACL rule is written and activated in the ACL (or just activated if it is already predefined and exists in the ACL 617). The ACL rule will specify that an incoming Ethernet message at the specified data port must have a specified source MAC address in order to be transmitted via the SUS. The specified source MAC address and the specified data port are associated with each other in a locked rule. By contrast, if the incoming Ethernet message on the specified data port does not have the specified source MAC address, then the SUS will not transmit the incoming Ethernet message, thereby blocking the incoming Ethernet message.

In addition, or in the alternative, an entry is written on the static MAC address table 618 that specifies the MAC address of the device and the data port ID are associated with each other.

Block 712: The session between the SUS and the mobile device ends.

Block 713: The mobile device ends the secure session with the SUS.

Block 714: The SUS periodically sends status updates to the network administrator. For example, the processor chip 401 generates the updates and sends these updates for transmission via the uplink data port 613.

Block 715: In the event that the verification at block 703 has failed, the field technician provides feedback via the mobile device that that a connected device is inaccessible to the network administrator computer. Alternatively, the mobile device and the SUS establish a secure communication session, and the mobile device transmits the failed verification to the SUS via NFC (or some other close proximity wireless communication).

It will be appreciated that using the process of FIG. 7A, a mobile device can transmit lock config data to a SUS. The lock config can be manually selected by a field technician or can be a pre-defined lock config.

Turning to FIG. 7B, an alternative embodiment is provided for locking the data ports on a SUS. In particular, the lock config is automatically determined by the SUS after monitoring the data ports for a predetermined amount of time. After the predetermined amount of time, the data ports are locked as they are. This enables a field technician to plug in devices into the SUS data ports, the SUS will thereafter automatically lock itself. This provides a plug-and-play operation.

In particular, blocks 701, 702 and 703 take place. At block 721, the SUS is run for a predetermined amount of time t. For example, the time period t begins after populating the dynamic MAC address table. In another example, the time period t begins after the SUS has been powered on. In another example, the time period t begins after a user input to the SUS has been provided (e.g., via the mobile device 201 via a secure communication session, or via a physical switch on the SUS, etc.). It will be appreciated that different conditions (or combinations of conditions) could be applied to automatically start the time period t. In an example aspect, the time period t is a predetermined amount of time stored in memory 404 of the SUS. In another example aspect, the time period t can be selected by a field technician and transmittable via the mobile device 201 via a secure communication session. In another example aspect, the time period tis self-determined by the SUS according to certain parameters.

In an example aspect, the time period t is 30 minutes. In another example aspect, the time period t is 1 hour. In another example aspect, the time period t is 24 hours.

Continuing with FIG. 7B, at block 722, after the certain period of time t, the processor chip 401 automatically generates a lock config based on the populated dynamic MAC address table at that time. In other words, after communication of client devices connected to the SUS have communicated with one or more other devices in the Ethernet network, it is expected that a configuration of MAC addresses at data ports, or unused data ports, or both, will emerge after some time period t. Therefore, the after the time period t, the SUS will automatically lock its data ports according to the detected configuration.

The process in FIG. 7B continues with blocks 710 and 711 for implementing the locking. Blocks 714 may also be implemented.

Turning to FIG. 7C, another example embodiment is provided for locking data ports on a SUS. For example, a company deploying one or more SUS devices will design and specify each SUS ID and the devices that are to be connected each data port of each SUS device, and may further specify which data ports are to remain unused. This design can be represented as a lock config data file specific to each SUS ID (or SUS device). The company may then upload the lock config data file and SUS profile (e.g., SUS device ID, SUS name, SUS location, etc.) to the SUS' non-volatile memory during manufacturing and production. The lock config data file is later used by the SUS to lock the data ports after the SUS is activated.

In FIG. 7C, at block 731, during manufacture or production of the SUS, a lock config is stored on non-volatile memory in the SUS. An example of non-volatile memory is the EEPROM 402-1 of the NFC module. Other memory can be used to store the lock config.

At block 732, after a predetermined setup condition has been detected, the processor chip 401 automatically obtains the lock config from the non-volatile memory.

Using the obtained lock config, the SUS proceeds with blocks 710 and 711 to lock the data ports.

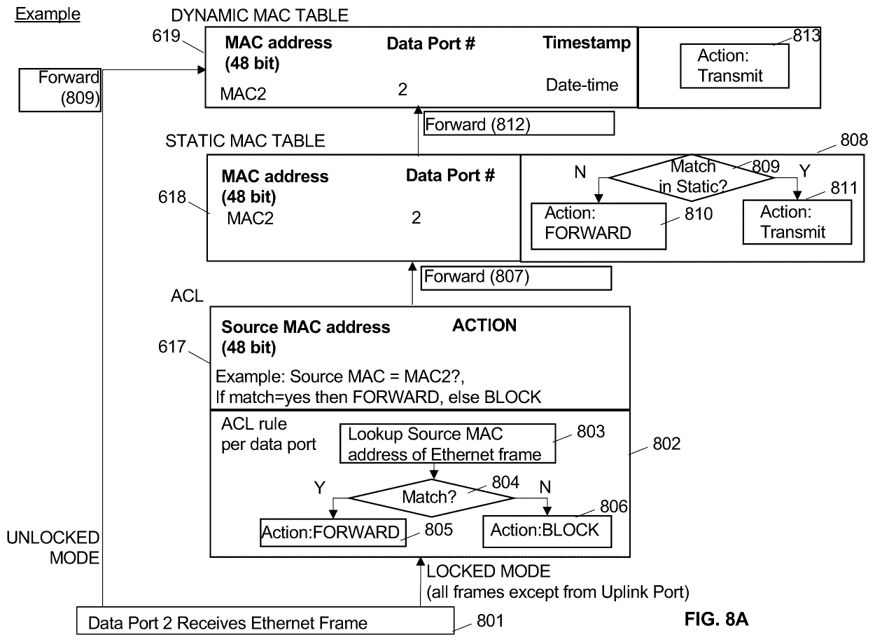

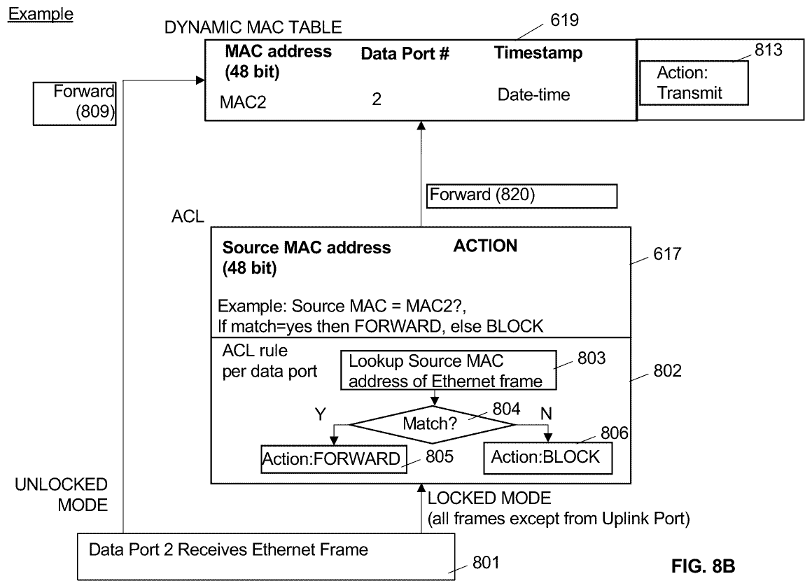

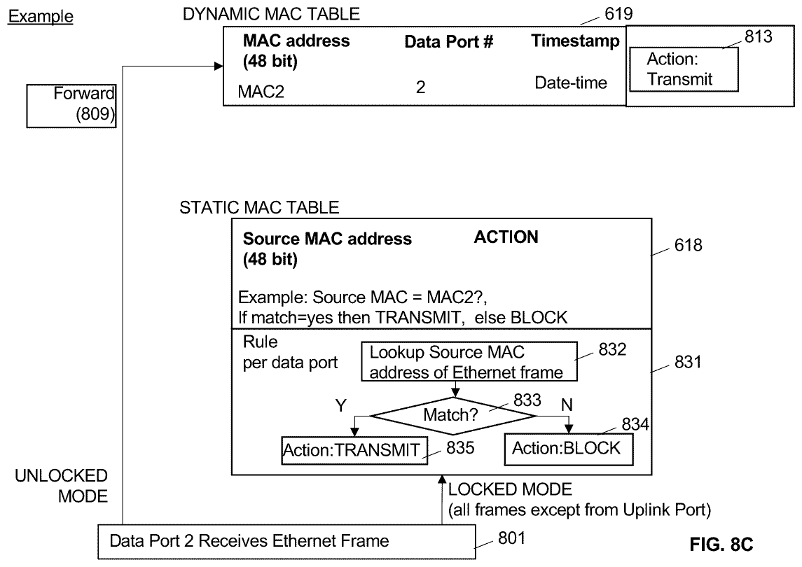

Turning to FIG. 8A, an example embodiment is provided for hierarchical wirespeed Ethernet frame filtering by the multi-port Ethernet switch 407 based on the configuration set in the ACL or in the static MAC address table, or both, and depending on whether a given data port is locked or unlocked. In the unlocked mode, an Ethernet frame goes through the normal L2 forwarding using the dynamic MAC table. In the locked mode, an Ethernet frame goes through ACL filtering, then the static MAC address table if applicable, and then gets forwarded, unless blocked by a previous stage.

The example in FIG. 8A takes place after one or more data ports on the SUS have been locked using the mobile device. In particular, the example is based on a particular data port 611 having a data port ID (which may be a number such as #2) and it is locked to a MAC address MAC2 of the client device 615. An ACL rule is written to the ACL 617 that specifies all Ethernet messages coming from data port 611 (or data port #2) must have the MAC address MAC2. The term MAC2 refers a specific MAC address. For example, it is a 48-bit MAC address with a string length of 12. For example, MAC2 has a format like 00:0a:95:9d:68:16 or 000a959d6816.

Block 801: The particular data port #2 on the SUS receives an Ethernet Frame. The Ethernet frame includes a source MAC address.

Block 802: A set of instructions or rules are stored in the ACL 617 of the multi-port Ethernet switch 407 that are associated with the particular data port #2. The multi-port Ethernet switch 407 accesses these instructions specific to data port #2, as the Ethernet frame arrived at data port #2.

In an example embodiment, instructions or rules are a list of locked data ports. In an example aspect, a given rule identifying a locked data port is also herein called a locking rule. These sets or instructions or rules are stored as a list on the multi-port Ethernet switch. The list of one or more locked data ports specifies that each of the one or more locked data ports is respectively configured to only communicate with a specified media access control (MAC) address. In another example embodiment, the list includes locked data ports that are respectively prohibited from all communication; in other words, to remain an unused data port. It will be appreciated that a list can include a combination of one or more locked data ports configured to only communicate with a respective specified MAC address, and can include one or more locked data ports that are prohibited from all communication.

In the example of FIG. 8A, the locking rule stored in the ACL (also herein called the ACL rule) specifies that data port #2 is locked to communicating with a specified MAC address.

Block 803: As part of the ACL rule for block 802, the switch 407 looks up or obtains the source MAC address from the Ethernet frame.

Block 804: The switch 407 determines if the obtained source MAC address from the Ethernet frame matches a stored MAC address in the ACL 617. The stored MAC address in the ACL was previously stored as part of the rule and is associated with the particular data port, in this example data port #2.

Block 805: If there is a match, then the switch 407 forwards the MAC address to the static MAC address table 618.

Block 806: If there is no match, then the switch 407 blocks the Ethernet frame (also called an Ethernet message) and does not transmit it via the SUS.

In this example, the obtained source MAC address equals or matches the stored MAC address (e.g., MAC2) associated with data port #2, as per the rule stored in the ACL 617.

Block 807: Therefore, in the example, the SUS forwards the MAC address MAC2 and the data port #2 to the static MAC address table 618 to conduct a check.

Block 808: For example, the check includes the switch 407 determining if there is a match of the MAC address MAC2 and the data port #2 in the static MAC address table (block 809). If there is a match, then the switch 407 uses the static MAC address table to transmit the Ethernet frame (also herein called the Ethernet message) to the destination data port of the SUS (block 811). The destination data port, for example, in the static MAC address table is associated with the source MAC address. In other words, the Ethernet frame is transmitted by the SUS to its associated destination address in the data network.

Alternatively, if there is no match in the static MAC address table, then the MAC address and data port are forwarded to the dynamic MAC address table (block 810).

Block 812: In an example where there is no match at the static MAC address table, the switch 407 forwards the information to the dynamic MAC address table 619. The information includes the MAC address MAC2, the data port #2, and the time stamp for an entry in the dynamic MAC address table.

Block 813: The switch 407, using the dynamic MAC address table, then transmits the Ethernet frame to one or more of the data ports.

Alternatively, if the data port #2 is not locked (or in an unlocked mode), then, responsive to receiving an Ethernet frame, an entry of the Ethernet frame from the device is forwarded and written directly to the dynamic MAC address table 619 (block 809). In an example aspect, in the unlocked mode, the switch 407 does not check the ACL for rules and nor does the switch 407 transmit the Ethernet frame using the static MAC address table.

In an example aspect, all Ethernet frames from the data ports, except from a designated uplink data port, are processed using the operations of FIG. 8A.

Turning to FIG. 8B, another example embodiment is shown, which is similar to the example of FIG. 8A. However, in FIG. 8B, the static MAC address table is not used. If the forwarding action (block 805) is executed by the switch 407, then the switch forwards the MAC address MAC2, data port #2, and time stamp to the dynamic MAC address table 619 (block 820). From the dynamic MAC address table, the Ethernet frame is transmitted to one or more of the data ports (block 813).

More generally, an example embodiment of the secure unmanaged Ethernet switch includes a multi-port Ethernet switch, and the multi-port Ethernet switch includes an ACL and a dynamic MAC table. The multi-port Ethernet switch is configured to at least: receive a source MAC address associated with an Ethernet frame via a given data port of the plurality of data ports; compare the source MAC address with a locking rule stored in the Access Control List, the locking rule specifying that the given data port is configured to only communicate with a specified MAC address; and, after determining that the source MAC address matches the specified MAC address, forward the Ethernet frame and the source MAC address to the dynamic MAC table for transmission to a destination address associated with the Ethernet frame.

Turning to FIG. 8C, another example embodiment is shown. After receiving the Ethernet frame at block 801, in the locked mode of a given data port, the switch looks up a rule for the given data port (e.g., data port #2) in the static MAC address table 618.

The rule determination at block 831 is similar to the rule determination at block 802 in FIG. 8A. However, in FIG. 8C, the switch looks to see if there is match of the source MAC address of the incoming Ethernet frame with a source MAC address in the static MAC address table (blocks 832 and 833). If there is no match, then the Ethernet frame is blocked (block 834). If there is a match, then the switch 407 transmits the Ethernet frame using the destination port associated with source MAC address, as stored in the static MAC address table (block 835).

Alternatively, if the data port is unlocked, then the MAC address from the incoming Ethernet frame us written to the dynamic MAC address table and then transmitted.

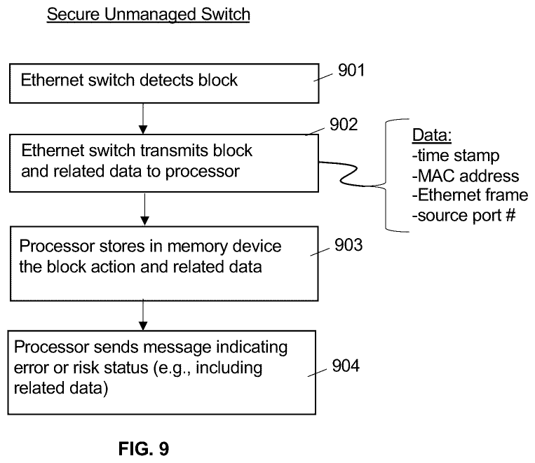

Turning to FIG. 9, a set of executable instructions are provided after detecting an incoming Ethernet frame is blocked.

Block 901: The multi-port Ethernet switch 407 detects a blocked Ethernet frame. The blocked Ethernet frame, for example, occurs at block 806.

In an example embodiment, a blocked Ethernet frame refers to an Ethernet frame that comes into a given data port, but the SUS determines there are no conditions that permit forwarding or transmission of the Ethernet frame. As a result, the Ethernet frame is dropped (also called “blocked”), becoming a blocked Ethernet frame. In a further example aspect, the process for determining whether or not to forward or transmit the Ethernet frame is described in the processes with respect to FIGS. 8A, 8B, and 8C.

Block 902: Responsive to detecting the blocked Ethernet frame, the multi-port Ethernet switch 407 transmits the blocked Ethernet frame (or parts of it) and related data to the processor chip 401. The data sent to the processor chip includes, for example, one or more of: the time stamp of when the Ethernet frame; the MAC address; the blocked Ethernet frame; and a source data port ID or number.

Block 903: The processor chip 401 stores the data in the memory 404. For example, it is stored in the history log 622.

Block 904: The processor chip 401 then sends a message indicating an error or risk status about the blocked Ethernet frame. For example, this message is sent via the managed switch 102 and to the network administrator computer 106.

The executable process described in FIG. 9 is used for error detection, or for detecting a potential attack. For example, an error or an attack on the SUS could cause the SUS to block incoming Ethernet frames into a given locked data port. For example, an unknown device is connected to the given locked data port, which causes the given locked data port to block incoming Ethernet frames. In another example, the given locked data port is configured to block receiving and transmitting Ethernet frames (e.g., to be locked to an unused state), and yet it is receiving incoming Ethernet frames that the SUS is blocking. The blocking of Ethernet frames would then trigger the SUS to transmit a message indicating a possible error or a possible attack.

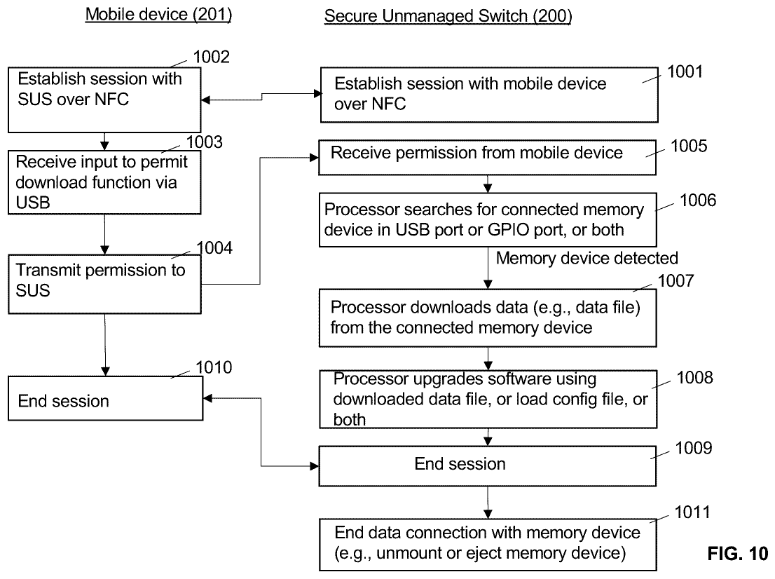

Turning to FIG. 10, an example embodiment of executable instructions is provided for uploading data to the SUS 200 using an external memory device, such as a USB key (also called a USB drive). In an example embodiment, a field technician carries a USB key storing software updates for the SUS. The USB key is inserted into the USB port 406. Only during a secure session with the mobile device 201, can the software updates from the USB key be transferred onto the memory device 404 of the SUS 200. Otherwise, data cannot be downloaded from the external memory device onto the SUS 200. This prevents an adversary from tampering with the firmware of the SUS.

In another example aspect, during the secure session with the mobile device, the SUS can upload or transmits data to the external memory device via the USB port 406.

Alternatively, during a secure session, data from an external device can be sent to the SUS via the GPIO port 405, or can be pulled from the SUS via the GPIO port and stored on the external device.

Block 1001: The SUS establishes a session with the mobile device 201 over NFC (or some other close proximity communication), including using the security processing of the TPM.

Block 1002: The mobile device also establishes the secure session with the SUS over NFC (or some other close proximity communication).

Block 1003: The mobile device receives an input to permit a download function via its USB port 406, or the GPIO port 405, or both.

Block 1004: The mobile device transmits the permission to the SUS.

Block 1005: The SUS receives the permission from the mobile device.

Block 1006: The SUS searches for a connected external memory device in the USB port 406 or the GPIO port 405, or both.

Block 1007: After detecting the connected external memory device (e.g., a USB key), the processor chip 401 initiates downloading data from the external memory device and stores the downloaded data into its memory 404.

Block 1008: In the example embodiment in which the downloaded data is software upgrade, the processor chip uses the downloaded data to upgrade the software of the SUS.

Block 1009 and block 1010: The SUS and the mobile device end the session.

Block 1011: After detecting the session has ended, the SUS ends or closes the data connection with the external memory device. For example, the external memory device is unmounted or ejected from the SUS software system.

In an alternative example, the data connection with the external memory device is closed or stopped before the secure session is ended.

In another example embodiment, the mobile device 201 has the data file for the software upgrade stored in its memory. During the secure session, the mobile device transmits an encrypted data file to the SUS over NFC. The SUS then decrypts the data file and uses it to upgrade the software. In this way, the field technician does not need to carry a USB key to upgrade the software of the SUS.

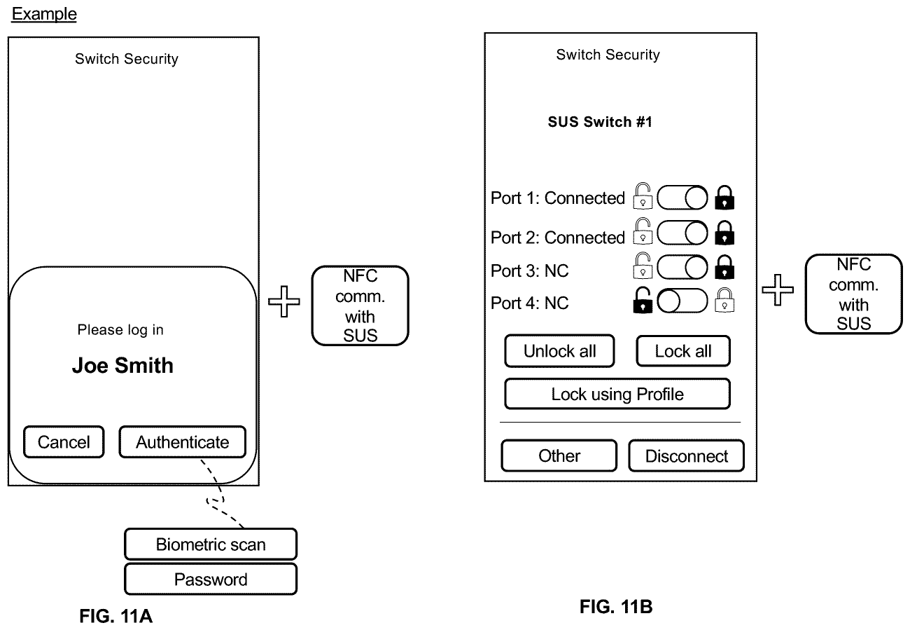

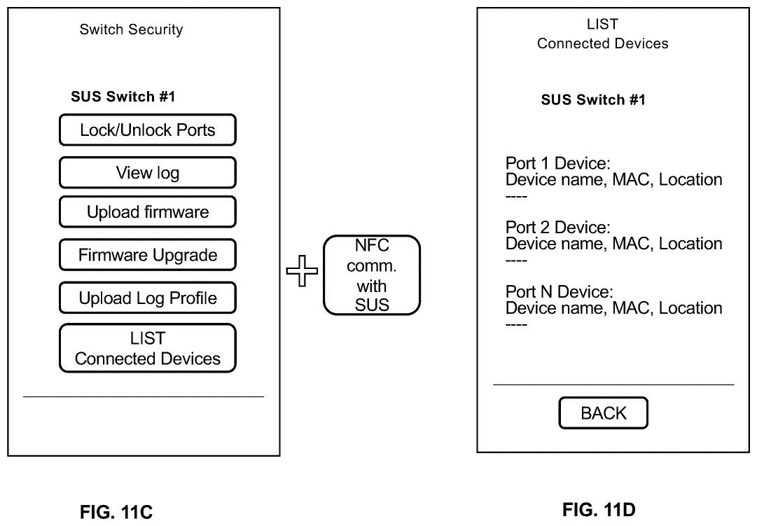

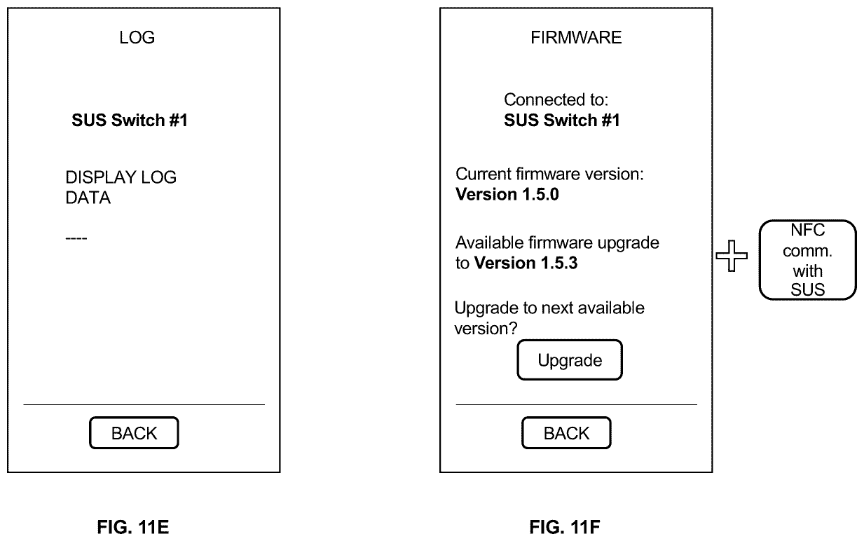

Turning to FIGS. 11A to 11F, example embodiments of GUIs are provided, which are displayed on the mobile device 201 of the field technician. The GUI content is displayable by the user agent 603, either as a SUS app 603b or using a web browser 603a.

At FIG. 11A, the GUI shows controls for the user to authenticate themselves. For example, the user (e.g., field technician) can authenticate themselves using a biometric scan using the biometric sensor 605. Alternatively, the user can enter a password into the GUI to authenticate themselves. In yet another alternative example embodiment, there is no authorization required to access the functionality of the user agent. A key exchange and verification is made with a given SUS (e.g,, SUS switch #1) by using NFC communication.

In an example embodiment, after authentication is successful, the GUI of the user agent displays the GUI of FIG. 11B.

The mobile device obtains data about SUS switch #1 and displays the data in FIG. 11B. The data, for example, includes a MAC address table. For example, FIG. 11B shows the data ports of the SUS switch #1 and shows which data ports are connected or not. FIG. 11B also displays in association with each data port a control to lock or unlock the data port. The current setting of the control also displays whether a given data port is currently locked or unlock. In this way, the user can control which specific data ports are to be locked, or are currently locked.

FIG. 11B also includes controls to unlock all data ports, lock all data ports, and to lock a subset of specific data ports according to one or more saved profiles. For example, a saved profile includes locking data ports #2 and #4 only, while the remaining data ports are unlocked.

The changes are implemented by transmitting the selected settings for the locked and unlocked data ports from the user device to the SUS switch #1 using NFC 24 communication.

By selecting a “Other” control, more options are displayed in the GUI of FIG. 11C. The user can also select a disconnect control to end the secure session between the mobile device and the SUS switch #1.

In FIG. 11C, a list of selectable controls or options are shown. These include, for example, a lock/unlock port control, a view log control, an upload firmware control, a firmware upgrade control, an upload log profile control, a list connected devices control, and a disconnect control.

The lock/unlock port control, which, after being selected, will display the GUI of FIG. 11B.

The view log control, after being selected, will display a history log of the SUS switch #1. For example, the history log is obtained from the history log 622 on the SUS memory 404. The history log GUI is shown in FIG. 11E.

The upload firmware control, after being selected, provides permission for an external memory device (e.g., USB key) to data connect to the SUS via its USB port (or GPIO port), and to upload the firmware from the external memory device onto the SUS. Alternatively, the mobile device transmits the firmware data to the SUS over NFC.

The firmware upgrade control, after being selected, shows the available firmware updates on the SUS to be used for upgrading the SUS. This is shown in FIG. 11F, and further includes showing the current firmware version and the next available version, as well as a control to initiate the firmware upgrade.

The upload log profile control, after being selected, transmits a log profile to the SUS over NFC communication. It will be appreciated that the SUS transmits the log profile or portions thereof, for example, along with diagnostic and history log data to the network administrator computer.

Returning back to FIG. 11C, the list connected devices control, after being selected, shows a list of connected devices at each data port. This is shown in FIG. 11D, which shows the data port ID or number, the device name, the MAC address of the device, and the location of the device.

In other example embodiments, the NFC module 402 of the SUS is used to initiate other functions.

In an example embodiment, the SUS comprises a NFC module and a Bluetooth™ module, and the user device (e.g., of the field technician) also includes a NFC module and a Bluetooth™ module. The user device and the SUS communicate over NFC to initially establish that the user device is a trusted device. After the SUS confirms that the user device is a trusted device by communicating over NFC, the SUS opens a data communication session with the user device over Bluetooth™. Using Bluetooth™, the SUS transmits data files to the user device. For example, these data files are logging data files of the SUS operation (e.g.,, operation details of the data ports), which may be real-time data or historical data, or both.

In another example embodiment, there are different categories of field technicians. A first set of field technicians has a first level of access to controlling a SUS, and a second set of field technicians has a second level of access to controlling the SUS. The levels of access are codified in the field technicians' user devices. In other words, a field technician with a first level of access will be able to use their user device to interact with the NFC module of the SUS, and the SUS will determine a first set of control operations that is permitted when interacting with the user device over NFC. A field technician with a second level of access will be able to use their user device to interact with the NFC module of the SUS, and the SUS will determine a second set of control operations that is permitted when interacting with the user device over NFC. In an example aspect, the first set of control operations, which corresponds to the first level of access, includes a greater number of control operations compared to the second set of control operations, which corresponds to the second level of access. In other words, different privileges or control access to the SUS can be determined over NFC communication.

In another example embodiment, the user device communicates with the SUS, over NFC, to initiate a detection diagnostic on the Ethernet cables to determine if a data port is shorted, or open, or to detect the distance from the SUS to a faulty device.

For example, an end device is expected to be plugged into an Ethernet cable at a first end, and the second end is connected to the SUS via a data port. However, if the first end of the Ethernet cable is not plugged into the end device, the SUS will detect that the cable is open at the actual span of the cable. Otherwise, if the first end of the Ethernet cable is plugged into the end device, it will not be detected as open. This detection will work whether the end device is powered or not.

In another example aspect, the user device can transmit a command to the SUS, via NFC, to run channel quality diagnostic checks.

Below are example embodiments of a secure unmanaged switch.

In an example embodiment, a secure unmanaged Ethernet switch comprises: a processor chip, a close proximity wireless communication module, a trusted platform module (TPM) chip, a memory device, a multi-port Ethernet switch, and a plurality of data ports;
the close proximity wireless communication module, the TPM chip, the memory device, and the multi-port Ethernet switch are in data communication with the processor chip; and
the plurality of data ports are in data communication with the multi-port Ethernet switch.

In an example aspect, the close proximity wireless communication module is a Near Field Communication module.

In another example aspect, the TPM chip stores security keys for establishing a secure communication session via the close proximity wireless communication module.

In another example aspect, the secure unamanged Ethernet switch further comprises a list of one or more locked data ports, which are a subset of the plurality of data ports; and wherein each of the one or more locked data ports is respectively configured to only communicate with a specified media access control (MAC) address or is respectively configured to prohibit all communication.

In an example aspect, the list is stored on the muti-port Ethernet switch in a Content Addressable Memory. In a further example aspect, the Content Addressable Memory is at least one of: a static MAC table, a dynamic MAC table, an Access Control List, and a Policy Control List.

In another example aspect, the close proximity wireless communication module is configured to receive a command to lock an additional one of the plurality of data ports, and the processor chip processes the command to write to the list on the multi-port Ethernet switch identifying the additional one as an additional locked data port.

In another example aspect, the list is stored in a memory in the multi-port Ethernet switch.

In another example aspect, the multi-port Ethernet switch comprises an Access Control List and a dynamic Media Access Control (MAC) table; and the multi-port Ethernet switch is configured to at least: receive a source MAC address associated with an Ethernet frame via a given data port of the plurality of data ports; compare the source MAC address with a locking rule stored in the Access Control List, the locking rule specifying that the given data port is configured to only communicate with a specified MAC address; and, after determining that the source MAC address matches the specified MAC address, forward the Ethernet frame and the source MAC address to the dynamic MAC table for transmission to a destination address associated with the Ethernet frame.

In another example aspect, the plurality of data ports comprise a plurality of RJ45 data ports and a plurality of single pair Ethernet (SPE) data ports.

In another example aspect, the secure unmanaged Ethernet switch further comprises a plurality of PHY devices that are respectively connected to the plurality of SPE data ports and to the multi-port Ethernet switch.

In another example aspect, the plurality of data ports comprise a plurality of RJ45 data ports. In another example aspect, the plurality of data ports comprise a plurality of fiber optic Ethernet data ports.

In an example embodiment, a secure unmanaged Ethernet switch comprises:
a processor chip, a close proximity wireless communication module, a memory device, a multi-port Ethernet switch, and a plurality of data ports;
the close proximity wireless communication module, the memory device, and the multi-port Ethernet switch are in data communication with the processor chip;
the plurality of data ports are in data communication with the multi-port Ethernet switch; and
wherein the multi-port Ethernet switch stores thereon a rule associated with at least a given data port that locks the given data port to only transmit data received via the given data port that originates from a specific source Media Access Control (MAC) address at the given data port.

In an example aspect, the processor chip is configured to transmit the rule to the multi-port Ethernet switch.

In another example aspect, the processor chip is configured to receive the rule via the close proximity wireless communication module.

In another example aspect, the secure unmanaged Ethernet switch further comprises a trusted platform module (TPM) chip that is in data communication with the processor chip, and is used to establish a communication session for the close proximity wireless communication module to receive the rule. In another example aspect, the close proximity wireless communication module is a Near Field Communication (NFC) module

In another example aspect, the processor chip is configured to obtain the rule from a non-volatile memory device, and wherein the non-volatile memory device is an electrically erasable programmable memory (EEPROM) that is part of the close proximity wireless communication module. In another example aspect, the close proximity wireless communication module is a Near Field Communication (NFC) module

In an example embodiment, a secure unmanaged Ethernet switch comprises:
a processor chip, a close proximity wireless communication module, a memory device, a multi-port Ethernet switch, and a plurality of data ports;
the close proximity wireless communication module, the memory device, and the multi-port Ethernet switch are in data communication with the processor chip;
the plurality of data ports are in data communication with the multi-port Ethernet switch; and
wherein the multi-port Ethernet switch stores thereon a rule associated with at least a given data port that locks the given data port to block transmission and reception of all data originating from and respectively coming into the given data port.

In an example embodiment, a secure unmanaged Ethernet switch comprises:
a processor chip, a Near Field Communication module, a memory device, a multi-port Ethernet switch, and a plurality of data ports;
the Near Field Communication module, the memory device, and the multi-port Ethernet switch are in data communication with the processor chip;
the plurality of data ports are in data communication with the multi-port Ethernet switch; and
a list of one or more locked data ports, which are a subset of the plurality of data ports, is stored on the multi-port Ethernet switch, and wherein each of the one or more locked data ports is respectively configured to only communicate with a specified media access control (MAC) address or is respectively configured to block all communication.

In an example aspect, the Near Field Communication module is configured to receive a command to lock an additional one of the plurality of data ports, and the processor chip processes the command to write to the list on the multi-port Ethernet switch identifying the additional one as an additional locked data port.

In an example aspect, the Near Field Communication module is configured to receive a command to unlock a given one of the one or more locked data ports, and the processor chip processes the command to remove the given one from the list stored on the multi-port Ethernet switch.

It will be appreciated that, using an app on the user device, the field technician can lock and unlock a given data port in secure unmanaged switch, and these changes to locking and unlocking are communicated from the user device to the secure unmanaged switch via NFC.

In an example aspect, the secure unmanaged Ethernet switch further comprises a power over data line control module to transmit power via a power coupling to a given data port of the plurality of data ports; the power coupling is electrically coupled to the given data port, the power over data line control module, and a PHY device; the PHY device is data connected to the multi-port Ethernet switch; and the processor chip transmits commands to the power over data line control module.

In an example aspect, the secure unmanaged Ethernet switch further comprising a Bluetooth module; wherein the Near Field Communication Module is configured to complete an authorization check with a user device; and, after completing the authorization check, the processor chip is configured to enable the Bluetooth module to communicate with the user device.

It will be appreciated that any module or component exemplified herein that executes instructions may include or otherwise have access to non-transitory computer readable media such as storage media, computer storage media, or data storage devices (removable and/or non-removable) such as, for example, memory chips, magnetic disks, optical disks. Computer storage media may include volatile and non-volatile, removable and non-removable media implemented in any method or technology for storage of information, such as computer readable instructions, code, processor executable instructions, data structures, program modules, or other data. Examples of computer storage media include random access memory (RAM), dynamic random access memory (DRAM), static random access memory (SRAM), read-only memory (ROM), solid-state ROM, electrically erasable programmable read-only memory (EEPROM), flash memory or other memory technology, or any other medium which can be used to store the desired information and which can be accessed by an application, module, or both. Any such computer storage media may be part of the servers or computing devices, or accessible or connectable thereto. Any application or module herein described may be implemented using computer readable/executable instructions that may be stored or otherwise held by such computer readable media.

It will be appreciated that different features of the example embodiments of the system and methods, as described herein, may be combined with each other in different ways. In other words, different devices, modules, operations, functionality and components may be used together according to other example embodiments, although not specifically stated.

The steps or operations in the flow diagrams described herein are just for example. There may be many variations to these steps or operations according to the principles described herein. For instance, the steps may be performed in a differing order, or steps may be added, deleted, or modified.

The elements and screenshots of the GUIs shown herein are just for example. There may be many variations to these GUI elements or operations according to the principles described herein. For instance, the GUI elements and operations may be performed in a differing order, or GUI elements or operations may be added, deleted, or modified.

It will also be appreciated that the examples and corresponding system diagrams used herein are for illustrative purposes only. Different configurations and terminology can be used without departing from the principles expressed herein. For instance, components and modules can be added, deleted, modified, or arranged with differing connections without departing from these principles.

Although the above has been described with reference to certain specific embodiments, various modifications thereof will be apparent to those skilled in the art without departing from the scope of the claims appended hereto.

1. A secure unmanaged Ethernet switch comprising:
a processor chip, a close proximity wireless communication module, a trusted platform module (TPM) chip, a memory device, a multi-port Ethernet switch, and a plurality of data ports;
the close proximity wireless communication module, the TPM chip, the memory device, and the multi-port Ethernet switch are in data communication with the processor chip; and
the plurality of data ports are in data communication with the multi-port Ethernet switch.

2. The secure unmanaged Ethernet switch of claim 1 wherein the close proximity wireless communication module is a Near Field Communication module.

3. The secure unmanaged Ethernet switch of claim 1 wherein the TPM chip stores security keys for establishing a secure communication session via the close proximity wireless communication module.

4. The secure unmanaged Ethernet switch of claim 1 comprising a list of one or more locked data ports, which are a subset of the plurality of data ports; and wherein each of the one or more locked data ports is respectively configured to only communicate with a specified media access control (MAC) address or is respectively configured to prohibit all communication.

5. The secure unmanaged Ethernet switch of claim 4 wherein the list is stored on the muti-port Ethernet switch in a Content Addressable Memory.

6. The secure unmanaged Ethernet switch of claim 5 wherein the content addressable memory is at least one of: a static MAC table, a dynamic MAC table, an Access Control List, a Policy Control List, and a Content Addressable Memory.

7. The secure unmanaged Ethernet switch of claim 4 wherein the close proximity wireless communication module is configured to receive a command to lock an additional one of the plurality of data ports, and the processor chip processes the command to write to the list on the multi-port Ethernet switch identifying the additional one as an additional locked data port.

8. The secure unmanaged Ethernet switch of claim 1 wherein the multi-port Ethernet switch comprises an Access Control List and a dynamic Media Access Control (MAC) table; and
the multi-port Ethernet switch is configured to at least:
receive a source MAC address associated with an Ethernet frame via a given data port of the plurality of data ports;
compare the source MAC address with a locking rule stored in the Access Control List, the locking rule specifying that the given data port is configured to only communicate with a specified MAC address; and
after determining that the source MAC address matches the specified MAC address, forward the Ethernet frame and the source MAC address to the dynamic MAC table for transmission to a destination address associated with the Ethernet frame.

9. The secure unmanaged Ethernet switch of claim 1 wherein the plurality of data ports comprise a plurality of RJ45 data ports and a plurality of single pair Ethernet (SPE) data ports.

10. The secure unmanaged Ethernet switch of claim 9 further comprising a plurality of PHY devices that are respectively connected to the plurality of SPE data ports and to the multi-port Ethernet switch.

11. The secure unmanaged Ethernet switch of claim 1 wherein the plurality of data ports comprise at least one of: a plurality of RJ45 data ports and a plurality of fiber optic Ethernet data ports.

12. The secure unmanaged Ethernet switch of claim 1 wherein the secure unmanaged Ethernet switch is part of an Ethernet Gateway device.

13. A secure unmanaged Ethernet switch comprising:
a processor chip, a close proximity wireless communication module, a memory device, a multi-port Ethernet switch, and a plurality of data ports;
the close proximity wireless communication module, the memory device, and the multi-port Ethernet switch are in data communication with the processor chip;
the plurality of data ports are in data communication with the multi-port Ethernet switch; and
wherein the multi-port Ethernet switch stores thereon a rule associated with at least a given data port that locks the given data port to only transmit data received via the given data port that originates from a specific source Media Access Control (MAC) address at the given data port.

14. The secure unmanaged Ethernet switch of claim 13 wherein the processor chip is configured to transmit the rule to the multi-port Ethernet switch.

15. The secure unmanaged Ethernet switch of claim 14 wherein the processor chip is configured to receive the rule via the close proximity wireless communication module.

16. The secure unmanaged Ethernet switch of claim 15 further comprising a trusted platform module (TPM) chip that is in data communication with the processor chip, and is used to establish a secure communication session for the close proximity wireless communication module to receive the rule.

17. The secure unmanaged Ethernet switch of claim 15 wherein the close proximity wireless communication module is a Near Field Communication (NFC) module.

18. The secure unmanaged Ethernet switch of claim 14 wherein the processor chip is configured to obtain the rule from a non-volatile memory device, and wherein the non-volatile memory device is an electrically erasable programmable memory (EEPROM) that is part of the close proximity wireless communication module.

19. The secure unmanaged Ethernet switch of claim 18 wherein the close proximity wireless communication module is a Near Field Communication (NFC) module.

20. A secure unmanaged Ethernet switch comprising:
a processor chip, a close proximity wireless communication module, a memory device, a multi-port Ethernet switch, and a plurality of data ports;
the close proximity wireless communication module, the memory device, and the multi-port Ethernet switch are in data communication with the processor chip;
the plurality of data ports are in data communication with the multi-port Ethernet switch; and
wherein the multi-port Ethernet switch stores thereon a rule associated with at least a given data port that locks the given data port to block transmission and reception of all data originating from and respectively coming into the given data port.

21. The secure unmanaged Ethernet switch of claim 20 wherein the processor chip is configured to transmit the rule to the multi-port Ethernet switch.

22. The secure unmanaged Ethernet switch of claim 21 wherein the processor chip is configured to receive the rule via the close proximity wireless communication module.

23. The secure unmanaged Ethernet switch of claim 22 further comprising a trusted platform module (TPM) chip that is in data communication with the processor chip, and is used to establish a secure communication session for the close proximity wireless communication module to receive the rule.

24. The secure unmanaged Ethernet switch of claim 22 wherein the close proximity wireless communication module is a Near Field Communication (NFC) module.

25. The secure unmanaged Ethernet switch of claim 21 wherein the processor chip is configured to obtain the rule from a non-volatile memory device, and wherein the non-volatile memory device is an electrically erasable programmable memory (EEPROM) that is part of the close proximity wireless communication module.

26. The secure unmanaged Ethernet switch of claim 25 wherein the close proximity wireless communication module is a Near Field Communication (NFC) module.

27. A secure unmanaged Ethernet switch comprising:
a processor chip, a Near Field Communication module, a memory device, a multi-port Ethernet switch, and a plurality of data ports;
the Near Field Communication module, the memory device, and the multi-port Ethernet switch are in data communication with the processor chip;
the plurality of data ports are in data communication with the multi-port Ethernet switch; and
a list of one or more locked data ports, which are a subset of the plurality of data ports, is stored on the multi-port Ethernet switch, and wherein each of the one or more locked data ports is respectively configured to only communicate with a specified media access control (MAC) address or is respectively configured to block all communication.

28. The secure unmanaged Ethernet switch of claim 27 wherein the Near Field Communication module is configured to receive a command to lock an additional one of the plurality of data ports, and the processor chip processes the command to write to the list on the multi-port Ethernet switch identifying the additional one as an additional locked data port.

29. The secure unmanaged Ethernet switch of claim 27 wherein the Near Field Communication module is configured to receive a command to unlock a given one of the one or more locked data ports, and the processor chip processes the command to remove the given one from the list stored on the multi-port Ethernet switch.

30. The secure unmanaged Ethernet switch of claim 27 further comprising a power over data line control module to transmit power via a power coupling to a given data port of the plurality of data ports; the power coupling is electrically coupled to the given data port, the power over data line control module, and a PHY device; the PHY device is data connected to the multi-port Ethernet switch; and the processor chip transmits commands to the power over data line control module.

31. The secure unmanaged Ethernet switch of claim 27 further comprising a Bluetooth module; wherein the Near Field Communication Module is configured to complete an authorization check with a user device; and, after completing the authorization check, the processor chip is configured to enable the Bluetooth module to communicate with the user device.
